(19) United States
(12) Patent Application Publication
(10) Pub. No.: US 2013/0126756 A1
(43) Pub. Date: May 23, 2013

(54) FLUORESCENCE IMAGING APPARATUS AND METHOD

(71) Applicants: Chunhui (Chris) Xu, Ithaca, NY (US); Scott Howard, South Bend, IN (US); Adam Straub, Ithaca, NY (US); Guanghao Zhu, Ithaca, NY (US)

(72) Inventors: Chunhui (Chris) Xu, Ithaca, NY (US); Scott Howard, South Bend, IN (US); Adam Straub, Ithaca, NY (US); Guanghao Zhu, Ithaca, NY (US)

(73) Assignee: Cornell University, Ithaca, NY (US)

(21) Appl. No.: 13/574,363

(22) PCT Filed: Jan. 24, 2011
(86) PCT No.: PCT/US11/22193

§ 371 Date: Jan. 29, 2013

Related U.S. Application Data
(60) Provisional application No. 61/297,583, filed on Jan. 22, 2010.

(51) Int. Cl. G01N 21/64; G02F 1/01

(52) U.S. Cl. CPC G01N 21/64; G02F 1/01
USPC 250/459.1; 359/238; 250/208.1

(57) ABSTRACT

A fluorescence emission imaging method and apparatus allows for high frame rate imaging in scattering medium as well as for fluorescence, phosphorescence, or luminescence lifetime imaging, time-resolved fluorescence, phosphorescence, or luminescence lifetime spectroscopy and imaging. A method involves providing an illumination beam, propagating the illumination beam to a light modulator array, modulating the illumination beam so as to generate an array of point sources, wherein each of the point sources is modulated at a frequency, imaging the modulated illumination beam on the object, and detecting a fluorescent, phosphorescent, or luminescent emission from the object. An optical imaging component in the form of a modulation mask has multiple bands. Each band has alternating transmissive and/or reflective and/or absorptive regions that are patterned such that light scanned over a band will be modulated at a band-related frequency.

### CROSS-REFERENCE TO RELATED APPLICATIONS

This application claims priority to U.S. Provisional application Ser. No. 61/297,583 filed on Jan. 22, 2010, the subject matter of which is incorporated herein by reference in its entirety to the fullest allowable extent.

### BACKGROUND OF THE INVENTION

1. Field of the Invention

Embodiments of the invention generally pertain to the field of optical imaging, more particularly to fluorescent emission-based (linear and non-linear) imaging and, most particularly, to fluorescent emission-based imaging apparatus, components, methods, and applications.

2. Description of Related Art

Conventional imaging microscopy with a multi-element detector generates high quality, high speed images of biological samples. Image quality is subsequently reduced in scattering media as points within the sample are not faithfully mapped to the detector. Point scanning microscopy allows for imaging in scattering media by illuminating a single diffraction limited point in the sample at a time, allowing for a single-element large-area detector to be used with no loss in resolution. However, the image is generated serially, introducing an inherent speed limitation.

Point scanning multiphoton microscopy (MPM) is widely used for optical sectioning deep into scattering tissue since nonlinear optical processes are confined to the focal volume of the microscope. The imaging acquisition speed of point scanning MPM, however, is typically slow and fundamentally limited by the maximum fluorescence generation rate, i.e., fluorescence saturation. Current technologies for fast imaging are based on parallel excitation of multiple pixels in space such as line-scanning microscopy (LSM) and multifoci multiphoton microscopy (MMM). Both are typically used for fast 3D imaging and, require parallel data acquisition through imaging of signal photons by a multi-element detector (typically a CCD). While satisfactory in a neat sample or a thin slice of tissue, the signal emitted from different resolution volumes will be completely mixed due to scattering, a well-known image smearing problem when strong scattering is present, as happens when imaging deep into tissue. Thus fast imaging techniques are typically not compatible with optical sectioning deep in scattering tissues.

In view of the foregoing problems and disadvantages in the prior art, the inventors have recognized the need for a new approach to provide point-resolved imaging in a LSM or MMM without imaging the signal photon, as well as the benefits and advantages in providing imaging components, apparatus incorporating those components, imaging methods, and applications of the apparatus and methods that overcome the other recognized shortcomings and disadvantages in the art.

### SUMMARY

An embodiment of the invention is directed to an imaging method. In a non-limiting exemplary aspect, a fluorescence emission imaging method involves the steps of providing an illumination beam; propagating the illumination beam to a light modulator array; modulating the illumination beam so as to generate an array of point sources, wherein each of the point sources is modulated at a frequency; imaging the modulated beam onto the object; and detecting a fluorescent emission from the object. In various non-limiting aspects: the illumination beam is a focused beam and, a focused beam in the form of a line; the beam is propagated to a linear light modulator array; each of the point sources is modulated at a different frequency; and the detected fluorescent emission from the object is converted to an electrical signal using a single element photon detector. According to an exemplary aspect, the method can be used for lifetime imaging (e.g., fluorescence, phosphorescence, luminescence) by performing the above steps to cause a fluorescent, phosphorescent, or luminescent emission, and additionally by performing the further steps of demodulating the emission, determining an intensity value of the emission at a particular frequency, detecting the modulated illumination beam as a reference signal prior to illuminating the object, and determining a relative phase difference between the emission and the reference signal at the particular frequency.

Another embodiment of the invention is directed to an optical imaging component that may comprise only an optical modulation mask. According to an aspect, the modulation mask is an optical chopper mask made up of multiple bands. Each band is comprised of alternating transmissive and/or reflective and/or absorptive regions. The alternating regions are patterned such that light (.g., object illumination light) scanned over a band will be modulated at a band-related frequency. The spatial frequencies of the bands may be constant or chirped (e.g., in the event that light might not be scanned in a linear manner over the modulator). The physical dimensions of the bands (i.e., thickness and length) are not necessarily restricted and may be tailored for different applications; for example, for bright, distinct frequency components, thick bands may be used, while thin bands may be useful for diffraction limited (high-resolution) images. Mask materials may include, e.g., standard reflective/transmissive photolithography masks (e.g., chrome on soda-lime glass), laser machined (etched) metals such as silver or high quality aluminum, or an active or passive microelectromechanical systems (MEMS) array. Alternatively, laser etching holes in a thin piece of metal is another way to construct a mask. The scale of features along the length of the band with the highest spatial frequency can be matched to the optically-resolvable, spot size on the mask of a beam focused through a scan lens to obtain optimum modulation rates. The bands can be stacked on top of one another in order of ascending or descending spatial frequency, and the width of each band can be made smaller than the optically-resolvable spot size on the mask of a beam focused through a scan lens in order to optimize spatial resolution in the imaging system. According to an illustrative aspect, a mask design template comprises horizontal bands each having a different spatial frequency. The thickness of the band is the resolution limit of the mask writer tool (e.g., 2 microns), while the width of the band is limited by the scan range of a scan mirror being used in an imaging system including the modulation mask. Horizontal bands with different spatial frequencies are stacked on top of each other. The highest spatial frequency of a horizontal band is limited to 1/(2× resolution limit of the mask writer tool) (e.g., 250 mm⁻¹). In the case of nonlinear florescence excitation, the lowest frequency will be limited to ½ of the maximum frequency, to avoid cross talk between higher order harmonics of the modulation of some pixels with the fundamental modulation frequencies of other pixels. In a non-limiting aspect, the optical imaging component is a high-speed spatial light modulator that includes a mirror array having the aforementioned modulation mask patterned thereon, a scan lens (e.g., an F-θ lens or any lens that maps angle to position), and a primary scanning component (e.g., galvo-scan mirror, resonant scan mirror, rotating polygon scanner, MEMS scanning mirrors, others known in the art). In a further non-limiting aspect, the optical imaging component is a multiphoton microscope that includes a multiphoton imaging system coupled to the aforementioned high-speed spatial light modulator.

Non-limiting embodied applications of the invention include optical imaging, high frame-rate imaging in highly scattering media, fluorescence, phosphorescence, or luminescence lifetime imaging, and time-resolved fluorescence, phosphorescence, or luminescence lifetime spectroscopy.

The foregoing and other objects, features, and advantages of embodiments of the present invention will be apparent from the following detailed description of the preferred embodiments, which make reference to the several drawing figures.

### BRIEF DESCRIPTION OF THE DRAWINGS

FIG. 1(a) schematically shows a layout on an optical imaging system according to an exemplary embodiment of the invention; FIG. 1(b) shows an image of a section of a modulation mask with dark areas indicating mirrored sections, a vertical scan line beam and scan direction arrows, according to an illustrative aspect of the invention; and FIG. 1(c) shows an entire modulation mask according to an illustrative aspect of the invention;

FIG. 2(a) shows a collected intensity signal; b) a modulation microscope transmission image of a 1951 AF test target; and (c) a modulation microscope transmission image of a 1951 AF test target with a 20×0.75 NA objective (left) and 40×0.6 NA objective (right). The smallest features are 2.2 μm×11.0 μm, according to an illustrative aspect of the invention;

FIG. 3 is an Epi-collected z-projection of (a) ex-vivo rat tendon SHG for 10 sections spaced by 2.0 μm; (b) 100 μm fluorescein dyed lens paper TPF for 5 sections spaced by 2 μm; and (c) Epi-collected image of ex-vivo rat tendon SHG, according to an illustrative aspect of the invention;

FIG. 4 is a photograph of a modulation microscope imaging system, according to an illustrative aspect of the invention;

FIG. 5(a) shows a target with four regions illuminated with different RF modulated light, and (b) collected light as a function of frequency, according to an illustrative aspect of the invention;

FIG. 6(a) shows full-frame modulation microscope data of transmitted light from 1951 AF Resolution test target, and (b) from a single vertical scan line shown in FIG. 2(b);

FIG. 7 schematically shows a high-speed spatial light modulator according to an exemplary embodiment of the invention;

FIG. 8 schematically shows a high-speed spatial light modulator according to an alternative exemplary embodiment of the invention; and

FIG. 9 schematically shows a layout on an optical imaging system useful for fluorescence, phosphorescence, or luminescence lifetime imaging or spectroscopy.

### DETAILED DESCRIPTION OF AN EXEMPLARY EMBODIMENT OF THE INVENTION

Reference will now be made in detail to the present exemplary embodiments of the invention, examples of which are illustrated in the accompanying drawings. Wherever possible, the same reference numbers will be used throughout the drawings to refer to the same or like parts.

Am embodiment of the invention is a method for fluorescence emission imaging comprising: providing an illumination beam, propagating the illumination beam to a light modulator array, modulating the illumination beam so as to generate an array of point sources, wherein each of the point sources is modulated at a frequency; imaging the modulated illumination beam on the object; and detecting a fluorescent emission from the object. Moreover, the method further enables lifetime imaging (e.g., fluorescence, phosphorescence, luminescence lifetime imaging) by applying the above steps to cause a fluorescent, phosphorescent, or luminescent emission, and additionally measuring the modulated light with a reference detector before imaging the modulated light onto the sample; demodulating the emission and signal from the reference detector; subtracting off the reference arm's measured phase from the sample's phase to determine a phase shift caused by, the sample. From that phase shift, and knowing the modulation frequency, extracting the local lifetime of each pixel independently and simultaneously. Exemplary embodiments of the invention also include a novel line scanning multiphoton microscope with parallel acquisition of pixels, allowing fast imaging deep into scattering tissue by illuminating several hundred diffraction limited points in a sample at one time, each modulated at a unique RF frequency, as well as a high-speed light modulator, and a modulation mask component of the high-speed light modulator. The imaging system advantageously exhibits a high modulation rate (>MHz), freedom from dispersion, and polarization independence.

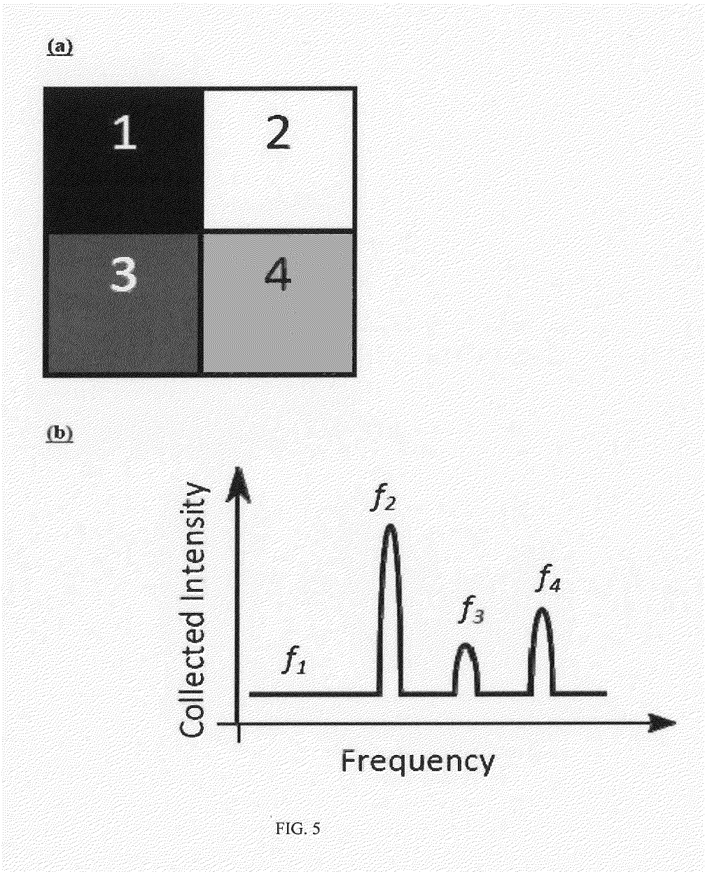

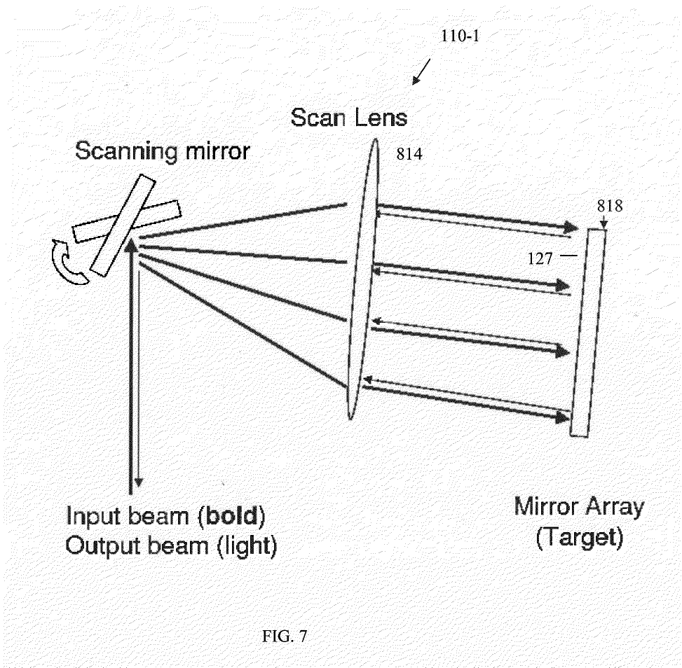

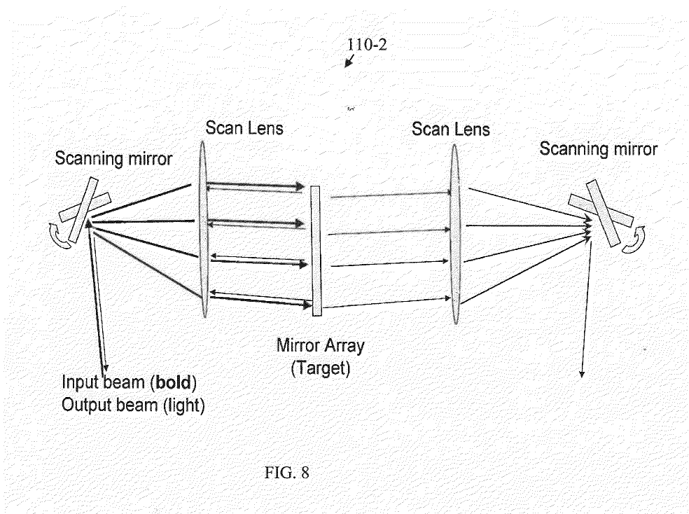

Briefly, the method involves detecting intensity information, then decoding to extract spatial information (FIG. 5). We image with a high-speed (MHz) spatial light modulator (FIGS. 7, 8) onto a sample to map frequency to position. This is accomplished by modulating each point in our sample at a frequency, collecting the nonlinear signal emitted by the sample onto a detector, and demodulating the signal to reconstruct the image.

Line scanning microscopy, for instance, line scanning multiphoton fluorescence microscopy, is a technique employed to generate images at the video frame rate or beyond. Although very fast, however, for line scanning based systems, the well, known image smearing problem is not solved when the subject of study is highly scattering. We address this problem by introducing a scheme, similar to subcarrier multiplexing technique applied in optical communications. The essence of the scheme is to excite a sample to fluoresce, phosphoresce, or luminesce, and code the information of different pixels along the line illumination to the amplitude part of different modulation carrier generated by the excitations, i.e., a one-to-one modulation frequency-to-space (Pixel) mapping is established. The image smearing problem for the line-scanning system is solved since the pixel information will be extracted from the modulation frequency domain using fast Fourier transform (FFT) software or hardware, instead from the spatial domain using a CCD camera. Physically, our scheme can be described as follows: we first create a focused line illumination, then, this line illumination will impinge onto a light modulator array, for instance a linear modulating linear mirror array, which may be a stationary mirror (e.g. lithographically defined micro-mirrors) or a micro-mirror array manufactured using the MEMS technique. Along the light modulator array, different beams will be modulated at different frequencies, as a result, an array of point sources will be formed with different point sources being modulated by different frequency. The array of point sources may be linear. Each point may have its own frequency or points may share a frequency. This point source array will then be imaged to the highly scattering sample to excite the fluorescence, phosphorescence, or luminescence, forming a one-to-one mapping between each of the individual micro-mirror and each of the individual pixel at the sample side. Further through the process of excitation, a superposition of fluorescence, phosphorescence, or luminescence components with different component modulated at different frequency is generated, carrying the pixel array information encoded in the modulation frequency domain. The excitation emission will then be detected and converted to the electrical signal using a detector, which may be a single element photon detector, such as a PMT or an APD. Software or hardware FFT then finally extracts out the image information.

Our method also enables fast fluorescence, phosphorescence, or luminescence lifetime microscopy and time-resolved fluorescence, phosphorescence, or luminescence spectroscopy through simultaneous multiple point acquisition. We utilized a linear spatial light modulator that scans a point (or line) over a reflective surface that contains a variably spatially modulated reflectivity (modulation mask) as a function of position. The reflected light is descanned to produce a stationary beam where each point of the beam has a unique modulation frequency. By projecting'the beam onto a sample with variable fluorescence, phosphorescence, or luminescence lifetime dyes, the phase of the emitted light can be used to determine the fluorescence, phosphorescence, or luminescence lifetime of the dye. By using both intensity and phase information, this invention can determine both the location and local conditions of dyes in biological samples.

Each point of our image is illuminated by modulated light pulse with a different modulation frequency at each point. We then detect the light from our target (at the fluorescence or non-linear wavelength) using a detector, which may be a single element detector (e.g. photomultiplier tube (PMT) or photodiode). No camera is necessary to image the sample. While a camera is not necessary, a multi-element (or multiple single element) detector (e.g. EMCCD camera) can be used as a method of increasing the signal-to-noise ratio of demodulated signals. In the shot-noise limit, collecting a subset of frequencies onto one or multiple detectors eliminates the shot noise contribution of frequency components that are not collected on that detector (or set of detectors). For example, if one detector (or pixel or subset of pixels in an array) collect light from frequencies 1-10, and another detector (or pixel or subset of pixels in an array) collects light from frequencies 11-20, shot noise from the second set of frequencies will be excluded from the signal in the first set of frequencies, and vice versa, in a non scattering sample. In a scattering sample, this technique will reduce the shot noise from one set of detectors from contributing to noise on another set, but not totally eliminate it since some modulated light will be scattered and detected by multiple detectors or sets of detectors. We then demodulate (i.e. take the Fourier Transform) of the received signal to recover the intensity of each modulation frequency. We map each modulation frequency to its corresponding pixel to recover the image.

We reach MHz nodulation rates using a stationary mirror (e.g. lithographically defined micro-mirrors) or a micro mirror array (for instance, one similar to Texas Instruments DLP) and scanner (e.g. scanning mirrors, resonant scanning mirrors, polygon scanner, acoustic-optical deflector). Using this system, we can generate a line of beams where each point of the line is modulated at a different RF frequency.

To overcome the limitations due to slow fluorescence, phosphorescence, or luminescence generation rate and thus pixel interference, we generate multiple beamlets along our line that is scanned (as done in multifoci multiphoton microscopy) without complicated beam splitter arrangements commonly used in literature. We can additionally create multiple beams by utilizing a simultaneous spatial and temporal focusing (SSTF) system. Such a system would simultaneously temporally decorrelate the beams and gain remote axial scanning capabilities.

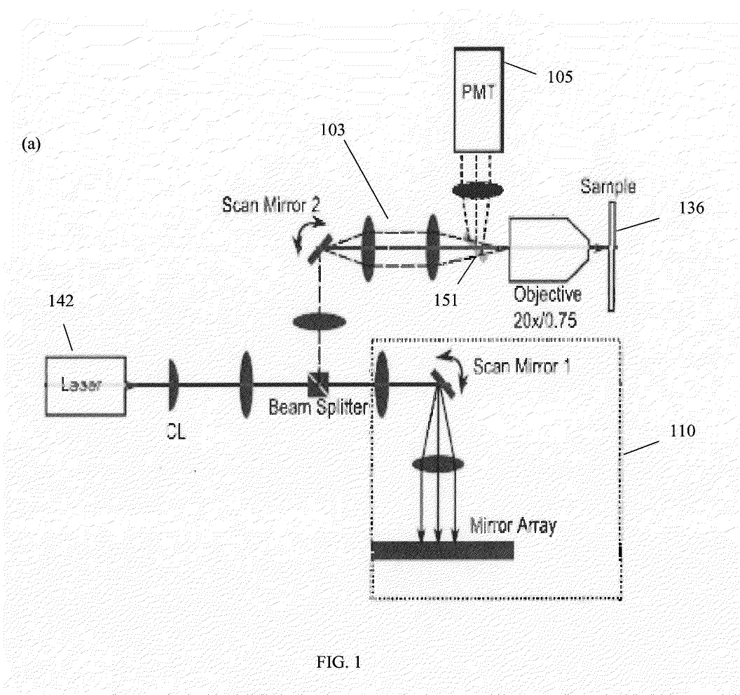

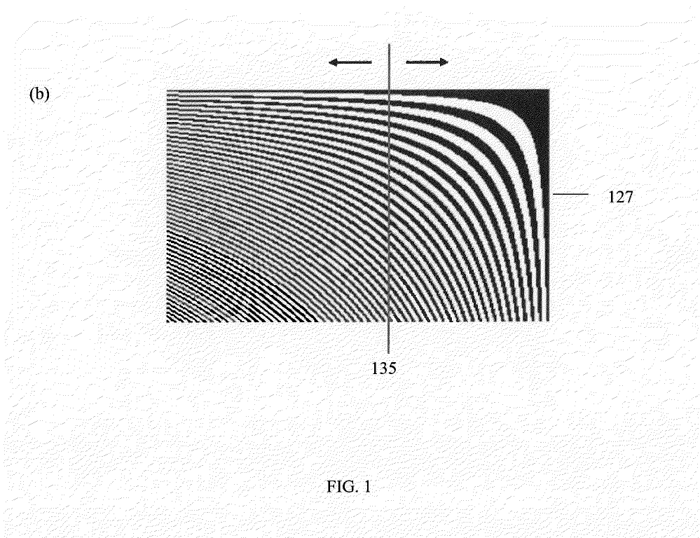

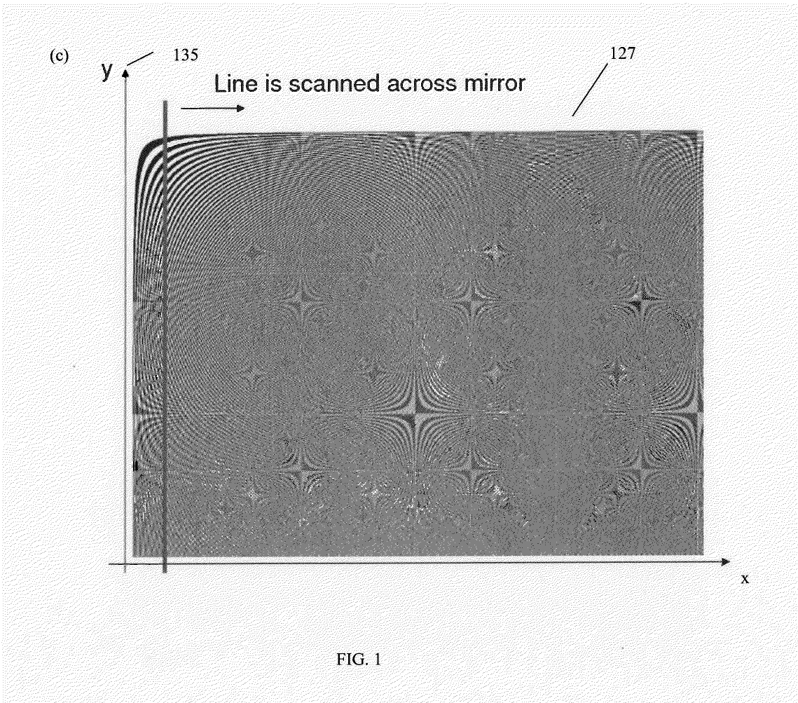

FIG. 1 shows the layout of an exemplary fluorescence, phosphorescence, or luminescence emission imaging system 100 that includes a linear spatial light modulator 110 coupled with a conventional line scanning microscope system 103; however, the camera (CCD array) of the line scanning microscope is replaced with a single point detector 105.

An exemplary linear spatial light modulator 110-1 is illustrated in FIG. 7 and includes a scanning mirror 812, a scan lens 814 and a mirror array 818 that comprises a modulation mask 127 as fully shown in FIG. 1(c) and partially illustrated in FIG. 1(b) The signal from the detector (105, FIG. 1) undergoes signal processing to reconstruct the image. Referring to FIG. 7, the illumination (input) light is modulated by scanning a line of light 135 (FIGS. 1(b, c) over the fixed target mirror 818 containing the modulation mask 127. Each row of the mask has a unique number of square wave cycles of “bright” and “dark” reflections as illustrated in FIG. 1(b, c). The scanning mirror 812 (FIG. 7) then acts as a descanner to send the output beam back towards the sample 136 (FIG. 1(a)). Such a mask configuration as presented in FIG. 1(c) has 1920×960 pixels. The top row has 1 cycle and the bottom row has 960 cycles. This mask can be fabricated using techniques known in the art, including semiconductor fabrication techniques (simple lithography and metallization) or using digital micromirror (DMM) arrays similar to the Texas Instruments DLP system.

In our experiments, we used a reflective and transmissive photolithography mask with 100 angstroms titanium followed by 1000 angstroms gold deposited onto a quartz substrate for high reflection and low absorption. A photosensitive polymer (e.g. photoresist) was layered on top of the metal. The photoresist was exposed by a mask writing tool (such as a laser mask writer or pattern generator) using a template as described below. The photoresist was developed per standard semiconductor fabrication protocols. The mask can be etched through the exposed photoresist using standard commercially available gold etchant. The photoresist was stripped per standard semiconductor fabrication protocols, producing the mask. Each pixel of our line 135, therefore, is modulated at the frequency corresponding to the line number divided by the scanner.

FIG. 8 schematically illustrates an alternative high-speed light modulator in which the input and output beam scanning mirrors and the input and output beam scan lenses are separate.

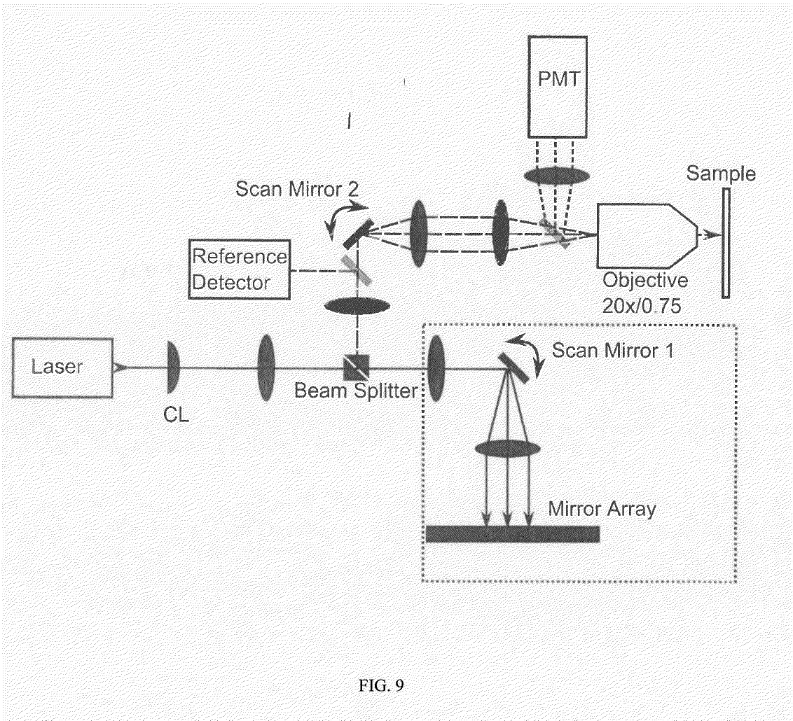

FIG. 9 schematically illustrates a fluorescent, phosphorescent, or luminescent emission lifetime measuring system 100-2 similar to the intensity-based imaging system 100 shown in FIG. 1, except that system 100-2 includes a reference detector 105-2 for detecting the modulated illumination beam as a reference signal prior to illuminating the object and determining a relative phase difference between the fluorescent, phosphorescent, or luminescent emission and the reference signal at the particular frequency.

### EXAMPLES

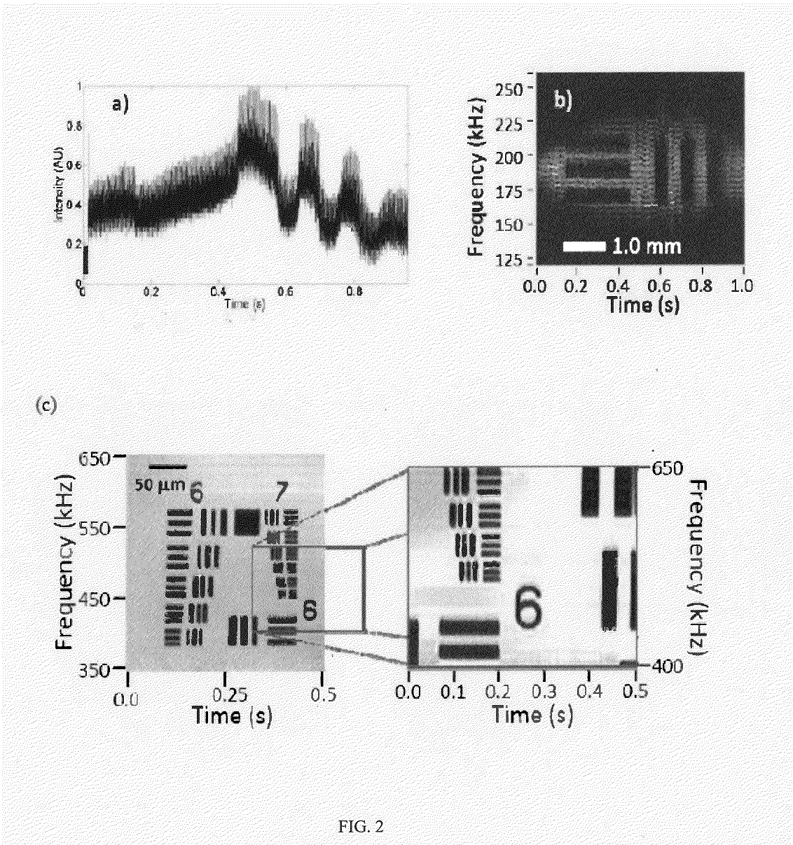

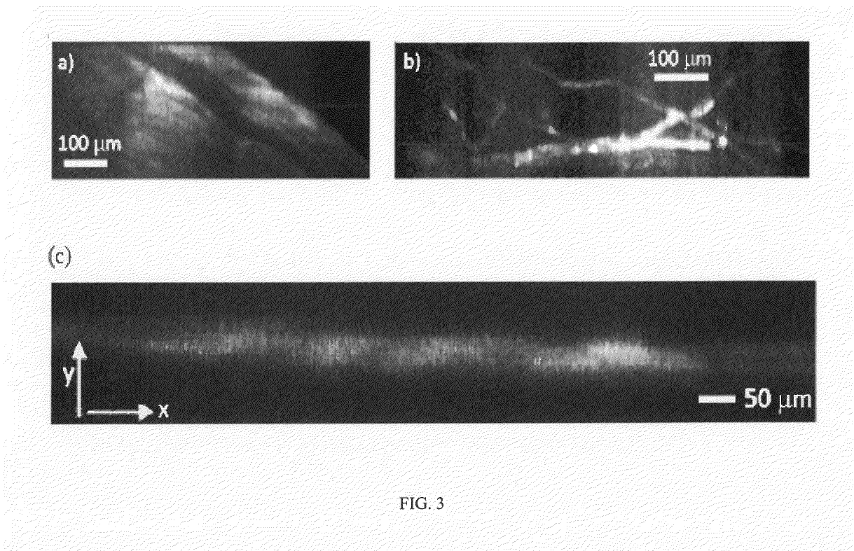

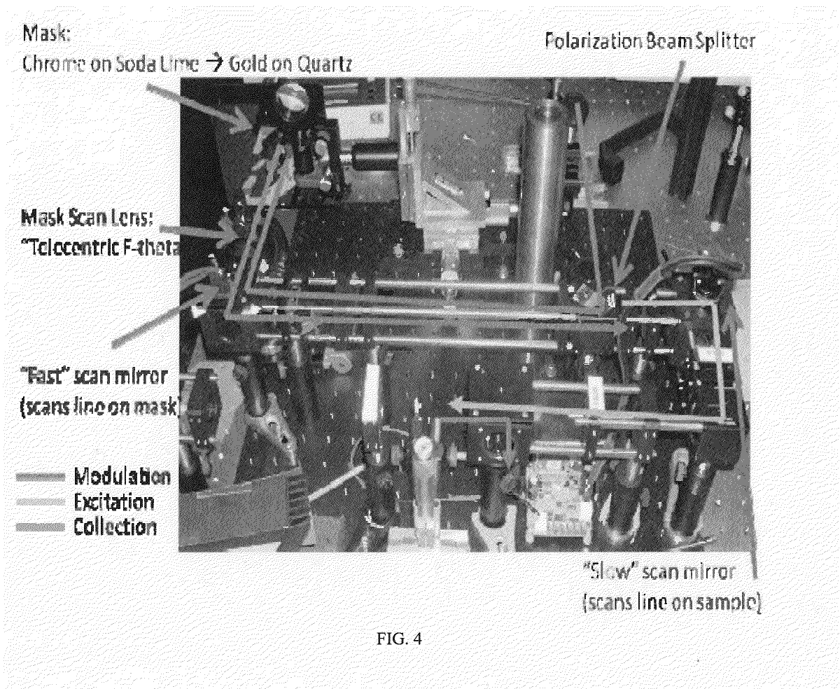

We characterized the system in transmission mode with a 1951 USAF Resolution Test Chart target generating a 115×374 pixel diffraction limited image as illustrated in FIGS. 2(a, b, c). Additionally, the intrinsic second harmonic generation from tendons extracted from the tail of a rat was imaged ex-vivo, as well as the intrinsic second harmonic generation from tendons extracted from the tail of a rat by epi-collecting the signal through the objective and detected by a PMT, with reference to FIGS. 3(a, b, c).

The sample response was measured by a single-element detecto (PMT) and demodulated to reconstruct the diffraction limited image. The excitation light was modulated by spatial light modulator embodied herein, that could modulate 5 μm×5 μm pixels at rates over 1 MHz by scanning a focused line across a lithographically patterned reflective surface.

The experimental set-up as shown in FIG. 1(a) further included a node-locked Ti:sapphire laser 142 that was used as the excitation source (wavelength=780 nm, approximately 100 fs pulse width, and 80 MHz repetition rate). We first created a focused line illumination 135 using a cylindrical lens (CL). This line illumination then impinges onto a spatial light modulator 110, generating a linear array of point sources with different point sources modulated by different frequency. This linear point source array is imaged onto the sample 136 to excite fluorescence, forming a one-to-one mapping between the modulation frequency and the pixel, i.e., the spatial information along the focused line is encoded in the frequency domain by modulating the excitation light intensity. The excited nonlinear signal is epi-collected through the objective and reflected off a dichroic mirror 151 onto a large area photomultiplier tube (PMT) detector 105 (Hamamatsu R7600U-200). The detected signal is then processed as a spectrogram to reconstruct the image: the y-axis is proportional to RF modulation frequency, x-axis is the time during the line scan, and the intensity of the pixels is the amount of power in the RF spectrum at a given time during the line scan.

High modulation rates are required,(1 MHz) to resolve distinct points along the line. Since commercially available linear SLMs cannot modulate at such speeds, we created the dispersion-free, polarization independent free-space optical chopper referred to herein as the high speed modulator 110 that can modulate an array of point sources at MHz rates by scanning a focused laser beam over a small (˜10 μm period) mirror grating on a photolithography mask 127. Each horizontal line on the photolithography mask had a different spatial frequency. The reflected light is then descanned by the same scan mirror, and is imaged onto the sample by the line scanning microscope.

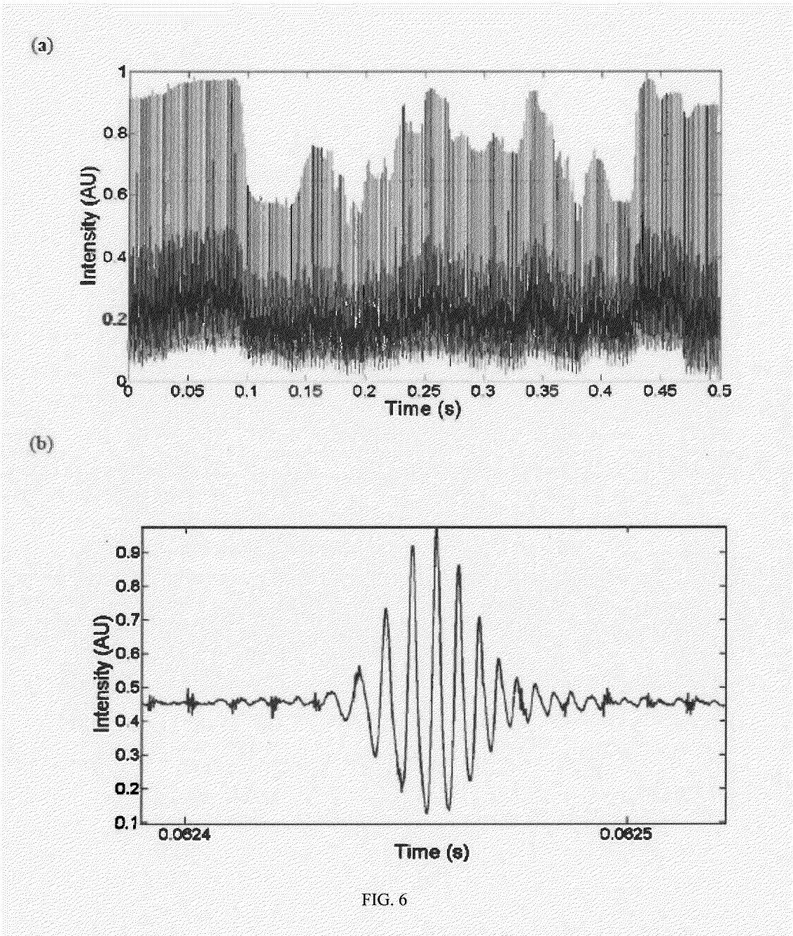

The concept of the modulation microscope, is demonstrated by imaging a 1951 USAF Resolution Test Chart in transmission mode. The transmitted light signal (FIGS. 2(a) and 6) is collected by a biased silicon photodiode with a 3.6 mm×3.6 mm active area.

The processed image is shown in FIGS. 2b and 2c. For 2b, the modulation frequencies are between 140 kHz and 230 kHz and the scan is over 1.0 s. The frame is approximately 90 pixels by 120 pixels with a frequency resolution of 1 kHz. For 2c, the modulation frequencies are between 350 kHz and 650 kHz and the scan is over 0.5 s. The frame is approximately 230×300 pixels.

The feasibility of multiphoton LSM with a single element detector is clearly demonstrated by imaging the intrinsic second harmonic generation (SHG) from tendons extracted from the tail of a rat ex-vivo (FIG. 3a) and the two photon florescence (TPF) from 50 μm fluorescein dyed lens paper (FIG. 3b). The 100×800 pixel x-y projection of a stack of optical sections through the tendon is presented in FIG. 3c. Excited nonlinear signal is epi-collected through the objective and detected by a PMT. This technique can also be extended by parallel acquisition of data for florescence, phosphorescence, or luminescence lifetime imaging microscopy, significantly increasing frame rates for FLIM imaging of long fluorescence, phosphorescence, luminescence lifetime dyes. The spatial resolution of the modulation microscope should be comparable to its corresponding multiphoton LSM or MMM (if multiple beamlets are used instead of a line).

All references, including publications, patent applications, and patents cited herein are hereby incorporated by reference in their entireties to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms i.e., meaning “including, but not limited to,”) unless otherwise noted. The term “connected” is to be construed as partly or wholly contained within, attached to, or joined together, even if there is something intervening.

The recitation of ranges of values herein are merely intended to serve as a shorthand method of referring individually to each separate value falling within the range, unless otherwise indicated herein, and each separate value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not impose a limitation on the scope of the invention unless otherwise claimed.

No language in the specification should be construed as indicating any non-claimed element as essential to the practice of the invention.

It will be apparent to those skilled in the art that various modifications and variations can be made to the present invention without departing from the spirit and scope of the invention. There is no intention to limit the invention to the specific form or forms disclosed, but on the contrary, the intention is to cover all modifications, alternative constructions, and equivalents falling within the spirit and scope of the invention, as defined in the appended claims. Thus, it is intended that the present invention cover the modifications and variations of this invention provided they come within the scope of the appended claims and their equivalents.

We claim:

1. A fluorescence, phosphorescence, or luminescence emission imaging method, comprising:
providing an illumination beam;
propagating the illumination beam to a light modulator array;
modulating the illumination beam so as to generate an array of point sources, wherein each of the point sources is modulated at a frequency;
imaging the modulated illumination beam on the object; and
detecting an emission from the object.

2. The method of claim 1, further comprising providing a focused illumination beam.

3. The method of claim 1, further comprising providing a focused illumination beam in the form of a line.

4. The method of claim 1, further comprising propagating the illumination beam to a linear light modulator array.

5. The method of claim 1, further comprising modulating the illumination beam so as to generate an array of point sources, wherein each of the point sources is modulated at a different frequency.

6. The method of claim 1, further comprising converting the detected emission from the object to an electrical signal using a single element photon detector.

7. The method of claim 1, further comprising:
demodulating the emission; and
determining an intensity value of the emission at a particular frequency.

8. The method of claim 7, further comprising:
detecting the modulated illumination beam as a reference signal prior to illuminating the, object; and
determining a relative phase difference between the emission and the reference signal at the particular frequency.

9. An optical imaging component, comprising:
a modulation mask, wherein the mask further comprises multiple bands, further wherein each band is comprised of alternating transmissive and/or reflective and/or absorptive regions that are patterned such that light scanned over a band will be modulated at a band-related frequency.

10. The optical imaging component of claim 9, wherein the bands are stacked on top of one another in order of ascending or descending spatial frequency.

11. The optical imaging component of claim 9, wherein respective horizontal sections of the bands each have a different spatial frequency.

12. The optical imaging component of claim 9, further comprising a gold reflective layer disposed on a substrate.

13. The optical imaging component of claim 12, wherein the substrate is quartz.

14. The optical imaging component of claim 9, further comprising:
an input/output beam scanner/descanner; and
a scan lens disposed to propagate the input beam from the scanner to the mask and the output beam from the mask to the scanner.

15. The optical imaging component of claim 9, further comprising:
an input beam scanner;
an output beam descanner;
an input beam scan lens disposed to propagate the input beam from the input beam scanner to the mask; and
an output beam scan lens disposed to propagate the output beam from the mask to the output beam scanner.
